(19) United States
(12) Patent Application Publication
(10) Pub. No.: US 2011/0309789 A1
(43) Pub. Date: Dec. 22, 2011

(54) CHARGER WITH DATA STORAGE

(75) Inventor: KRISHNA PRASAD, Bangalore (IN)

(73) Assignee: Kyocera Wireless Corp, San Diego, CA (US)

(21) Appl. No.: 12/819,695

(22) Filed: Jun. 21, 2010

(51) Int. Cl. H02J 7/00

(52) U.S. Cl. 320/107

(57) ABSTRACT

A particular charger configured to be electrically coupled and communicatively coupled to a particular portable electronic device is described. The particular charger includes an AC/DC converter, a controller, a charger memory, a charger cable, and an authentication module. The controller provides a means for processing the data from the particular portable electronic device memory by synchronizing the device memory with the charger memory. The illustrative portable electronic device is a wireless handset.

### FIELD OF THE INVENTION

The present invention relates to an apparatus and method for storing data within the housing of a charger that is associated with a portable electronic device. More particularly, the invention relates to a particular charger having a charger memory that synchronizes with a particular portable electronic device memory while the device is charging.

### BACKGROUND

Portable electronic devices are popular devices used by individuals to store data, manage information, and communicate with other electronic devices. Examples of portable electronic devices include mobile phones, wireless handsets, personal display adapters, cellular telephones, wireless communication devices, digital and analog data and voice recorders, sensors, pagers, watches, video display devices, audio devices, digital cameras, video recorders, or any other such portable electronic device.

Typically, portable electronic devices such as mobile phones synchronize the data housed within the electronic device with a personal computer (PC) via a data cable or Bluetooth connection. In operation, client software associated with the personal computer is used to copy the portable electronic device data to the personal computer. This process is inconvenient, time consuming and may be difficult to perform because software has to be loaded on the user's personal computer and the drivers on the personal computer have to support the portable electronic device. Even if this task of connecting the portable electronic device to the PC is completed, the task is performed at irregular intervals.

Additionally, the potential for data loss is further compounded by the possibility of the portable electronic device being lost or stolen. In these instances, the data lost may be invaluable, especially if the data has not been synched to the PC. For example, a busy business person would find data loss a significant burden to overcome.

It would therefore be beneficial to provide an apparatus and method for that would preserve the memory of the portable electronic device, e.g. phone, so that the memory is safe.

Additionally, it would be beneficial to provide an apparatus and method wherein the data of the portable electronic device is preserved, even if the portable electronic device is either lost or stolen.

Furthermore, it would also be beneficial to provide an apparatus and method that is cost effective to implement.

### SUMMARY

A charger configured to be electrically coupled and communicatively coupled to a portable electronic device is described. The charger includes an AC/DC converter, a controller, a charger memory, a charger cable, and an authentication module. The controller provides a means for processing the data from the particular portable electronic device memory by synchronizing the device memory with the charger memory. The illustrative portable electronic device is a wireless handset.

The AC/DC converter converts alternating current to direct current and charges the portable electronic device. The controller is housed within the charger housing. The charger memory is also housed within the charger housing. The charger memory is communicatively coupled to the controller and the charger memory is associated with the particular portable electronic device. The charger cable is operatively coupled to the controller and the AC/DC converter, and the charger cable has a first cable interface end that is configured to interface with the portable electronic device having a particular portable electronic device memory. The charger cable includes at least one data cable configured to communicate data from the portable electronic device memory to the charger memory and a power cable configured to transfer the direct current to the portable electronic device. The authentication module associated with the charger is configured to verify that the particular portable electronic device memory is associated with the particular charger. The controller is configured to synchronize the particular portable electronic device memory with the charger memory.

Also, the first cable interface end of the charger cable that interfaces with the portable electronic devices may include a USB cable interface. Additionally, the charger cable may include a second cable interface end that is configured to interface with the particular charger. Furthermore, the charger memory may be removable from the charger housing.

In the illustrative embodiment, the particular electronic device is a wireless handset that includes an internal memory and the charger memory is configured to synchronize with the internal memory. The wireless handset may also include an external memory and the charger memory is configured to synchronize with the external memory. The charger memory may also be removable from the charger housing and may be installed in another wireless handset, and the other wireless handset is configured to be charged by the particular charger.

A method for a charger to store the memory associated with a portable electronic device, the method comprises enabling the charger to be fixedly coupled to a power source. The method then proceeds to verify that the particular portable electronic device memory is associated with the particular charger with the authentication module associated with the charger. The data from the particular portable electronic device memory is then synchronized with the charger memory.

The charger memory may also be removed from the charger housing. The method may also proceed to install the charger memory in another wireless handset and enable the other wireless handset to download data in the charger memory. The method may also include enabling the other wireless handset to be charged by the particular charger and enabling the other wireless handset to be synchronized by the particular charger.

### DRAWINGS

The present invention will be more fully understood by reference to the following drawings which are for illustrative, not limiting, purposes.

FIG. 1 shows an illustrative prior art charging system.

FIG. 2 shows an illustrative charger, in which the wireless handset is electrically coupled and communicatively coupled to a charger with data storage.

FIGS. 3A and 3B each present different cable connections that connect two different chargers to an illustrative wireless handset.

FIG. 4 shows a detailed view of an illustrative handset having internal memory and external memory.

FIG. 5 shows an illustrative flowchart of the method for having the charger store the memory associated with a portable electronic device.

### DETAILED DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the charger, wireless handset, and methods described hereinafter may vary as to configuration and as to details.

A particular charger configured to be electrically coupled and communicatively coupled to a particular portable electronic device is described. The particular charger includes an AC/CD converter, a controller, a charger memory, a charger cable, and an authentication module. The controller provides a means for processing the data from the particular portable electronic device memory by synchronizing the device memory with the charger memory. The illustrative portable electronic device is a wireless handset.

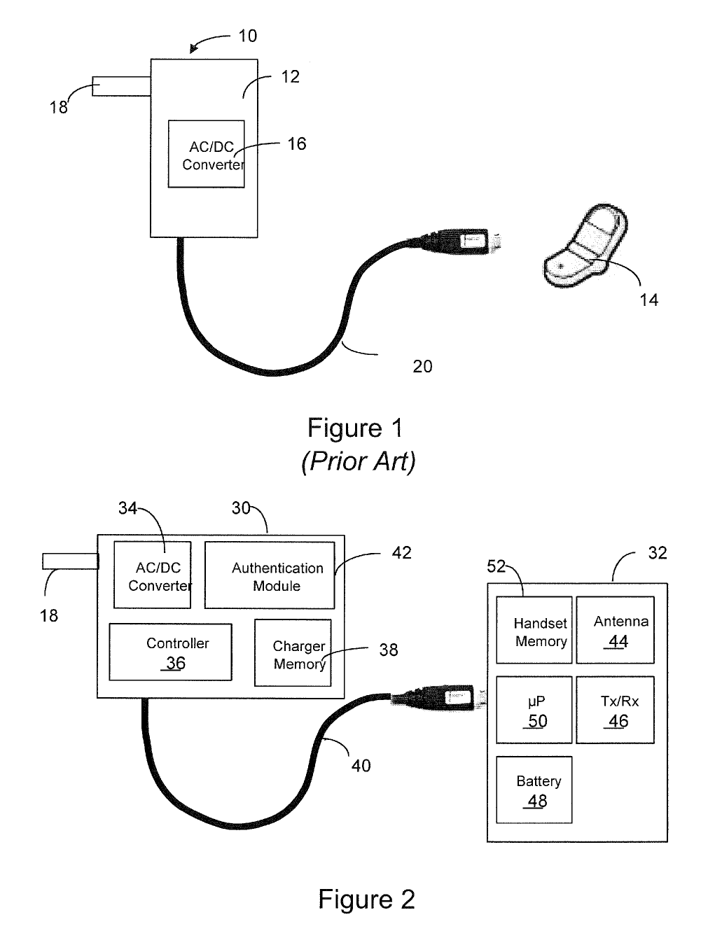

Referring to FIG. 1 there is shown a prior art charging system 10. The charging system includes a charger 12 that charges illustrative wireless handset 14. The charger includes an AC/DC converter 16 that receives alternating current from plug 18 and converts the alternating current to direct current and charges the wireless handset 14 with illustrative cable 20. The charging system 10 simply performs the operation of charging the portable electronic device, i.e. the wireless handset 14.

Referring to FIG. 2 there is shown an illustrative charger 30, in which a portable electronic device 32 such as a wireless handset is electrically coupled and communicatively coupled to a charger 30. The charger includes an AC/DC converter 34, a controller 36, a charger memory 38, a charger cable 40, and an authentication module 42.

The illustrative portable electronic device is the wireless handset 32. The wireless handset 32 includes an antenna 44 operatively coupled to a transceiver 46. The wireless handset 32 also includes a battery 48 that is charged by the charger 30. A wireless handset processor 50 is configured to be communicatively coupled to the charger controller 36 via cable 40. The wireless handset memory 52 stores data that corresponds to the wireless handset 32.

In operation, the charger controller 36 provides a means for processing the data from the wireless handset memory 52 by synchronizing the device memory 52 with the charger memory 38. The charger controller 36 is configured to generate a copy of the data associated with the wireless handset memory 52. The charger controller synchronizes the copy each time the wireless handset 50 is charged. The controller proceeds to store the copy of the data in the charger memory 38. Hence, the charger memory 38 is updated each time the portable electronic device is charged.

The AC/DC converter 34 converts alternating current to direct current and charges the wireless handset 32. The controller 36 is housed within the charger 30 housing. The charger memory 38 is also housed within the charger 30 housing. The charger memory 38 is communicatively coupled to the controller 36 and the charger memory 38 is associated with the wireless handset 32.

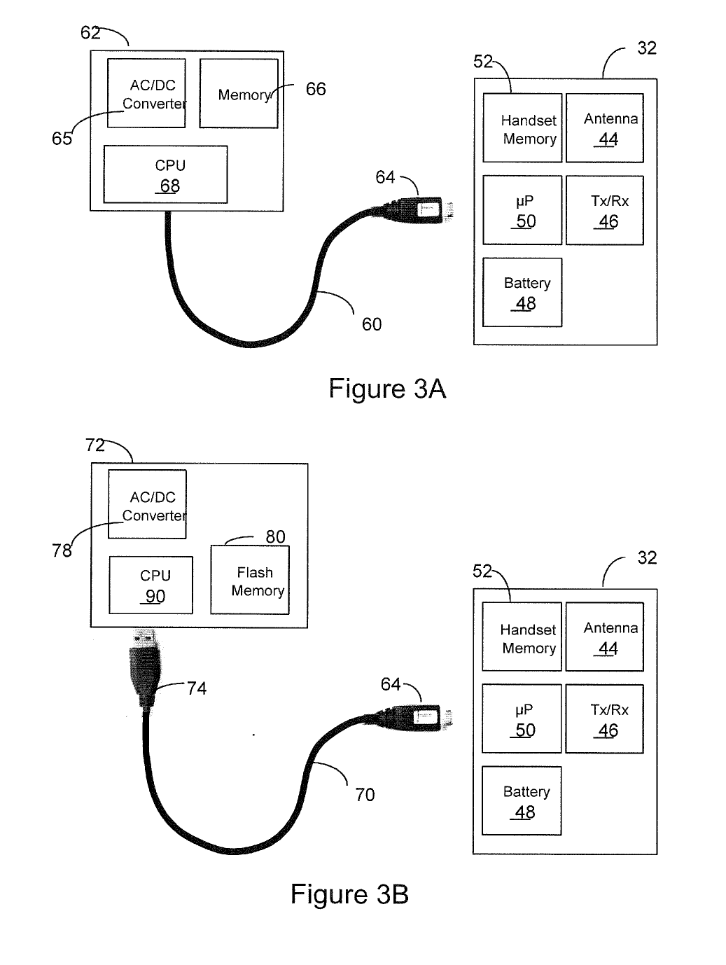

The charger cable 40 is operatively coupled to the controller 36 and the AC/DC converter 34. The illustrative charger cable 40 has a first cable interface end 64 (see FIG. 3A) that is configured to interface with the wireless handset 32 having a particular wireless handset memory 52.

The charger cable 40 includes at least one data cable configured to communicate data from the wireless handset memory 52 to the charger memory 38 and a power cable configured to transfer the direct current to the portable electronic device.

The authentication module 42 associated with the charger 30 is configured to verify that the wireless handset 32 is associated with the particular charger 30. The authentication module 42 is configured to copy data from a particular wireless handset 32 by reading the Electronic Serial Number (ESN) associated with the handset 32. The ESN uniquely identifies mobile devices and is 32 bits long. As the supply of available unassigned ESNs depletes, a new serial number format referred to as Mobile Equipment ID (MEID) may also be used. With respect to the wireless handset, the Number Assignment Module (NAM) and the Mobile Identification Number (MIN) can be used to identify the particular wireless handset. The MIN is stored in a database managed by the carrier and can be changed at any time. The controller 36 is configured to synchronize the wireless handset memory 52 with the charger memory 38.

Referring to FIG. 3A there is shown another illustrative cable 60 that connects another charger 62 to wireless handset 32. The cable 60 includes the first cable interface end 64. By way of example and not of limitation, the first cable interface end 64 of the charger cable 60 is a USB cable interface such as a Micro-USB cable interface. The illustrative Micro USB ports and plugs are smaller than some charging interfaces and are also sturdier. Additionally, Micro USB includes a locking mechanism to prevent accidental disconnection.

The illustrative charger 62 includes an AC/DC converter 65, a memory 66, and a CPU 68. The illustrative charger 62 includes a CPU that provides a means for processing and controlling the flow of data from the wireless handset 32.

Referring to FIG. 3B there is shown yet another cable 70 that connects charger 72 to the wireless handset 32. In this illustrative embodiment, the charger cable 70 includes a first cable interface end 64 and a second cable interface end 74 that is configured to interface with the charger 74. By way of example and not of limitation, the second cable interface end 74 may also be a USB interface.

The charger 72 includes an AC/DC converter 78, a flash memory 80 and a central processing unit 90. In this illustrative embodiment, the charger memory 80 is a Flash memory that can be removed from the charger housing. Additionally, the charger memory 80 can be expandable to meet a particular user needs. For example, the wireless handset may have an external flash memory of 8 GB and internal memory of 2 GB, so the charger memory may be 16 GB.

The charger memory 80 can then be installed in another wireless handset (e.g. wireless handset 100) that enables the other wireless handset 100 to download data in the charger memory 80. This approach would enable the other wireless handset 100 to be charged by the particular charger 72 and be synchronized by the particular charger 72.

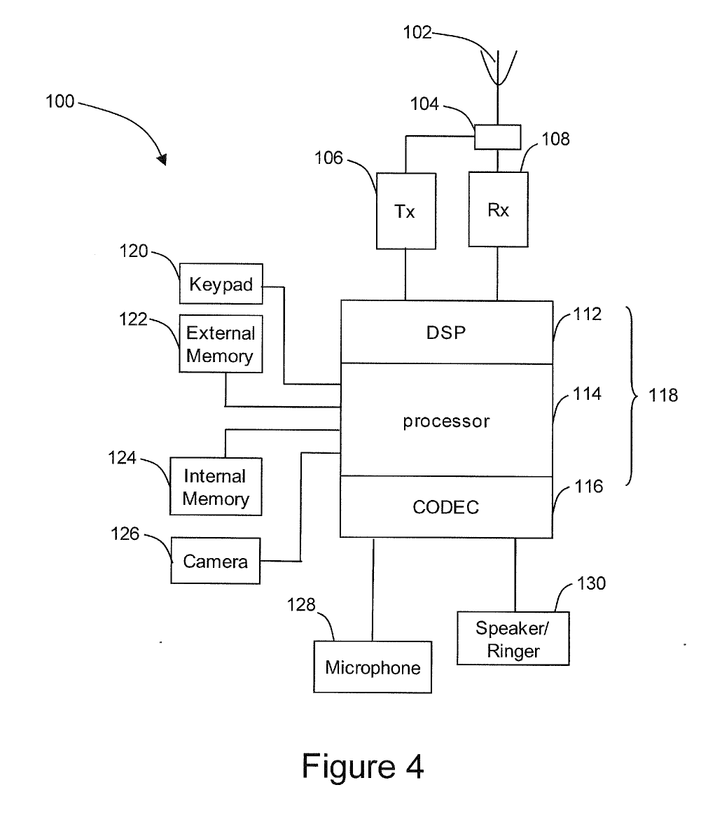

FIG. 4 shows a detailed view of an illustrative wireless handset 100 having internal memory and external memory. The illustrative wireless handset 100 can also be referred to as a wireless communication device, a mobile handset, mobile phone, wireless phone, portable cell phone, cellular phone, portable phone, a personal digital assistant (PDA), or any type of mobile terminal which is regularly carried by a user and has all the elements necessary for operation in a wireless communication system. It shall be appreciated by those of ordinary skill in the art that the terms wireless communication device, wireless handset, mobile handset, wireless phone, and mobile phone are interchangeable.

The illustrative multimode wireless handset 100 comprises a first antenna element 102 that is operatively coupled to a duplexer 104, which is operatively coupled to a multimode transmitter module 106, and a multimode receiver module 108. The antenna element 102 may be mounted on either the display housing (not shown), the keypad housing (not shown), or a combination thereof.

An illustrative control module 118 comprises a digital signal processor (DSP) 112, a processor 114, and a CODEC 116 that are communicatively coupled to the transmitter 106 and receiver 108. It shall be appreciated by those of ordinary skill in the art that the transmitter module and receiver module are typically paired and may be embodied as a transceiver. The DSP 112 may be configured to perform a variety of operations such as controlling the antenna 102, the multimode transmitter module 106, and the multimode receiver module 108.

The processor 114 is operatively coupled to a keypad 120, an external memory 122, an internal memory 124 and camera 126. Additionally, the processor 112 is also operatively coupled to a CODEC module 116 that performs the encoding and decoding operations and is communicatively coupled to microphone 128 and a speaker or ringer 130. The CODEC module 116 is also communicatively coupled to a display (not shown) and provides the encoding and decoding operations for video.

The internal memory 124 refers to memory that is embedded into the wireless handset. The external memory 122 is memory that is used to supplement the internal memory such as a Flash memory chip card. In one embodiment, the external memory 122 is the Flash memory chip card 80. The installation of the Flash memory chip card 80 as external memory 122 enables the wireless handset 100 to download data from the charger 72.

The wireless handset 100 is configured to be charged by one of the chargers 30, 62 and 72. In this illustrative embodiment, the charger memory 38, 66 and 80 is configured to synchronize with the internal memory 124. The wireless handset may also include an external memory 122 and the charger memory 38, 66 and 80 is configured to synchronize with the external memory 124.

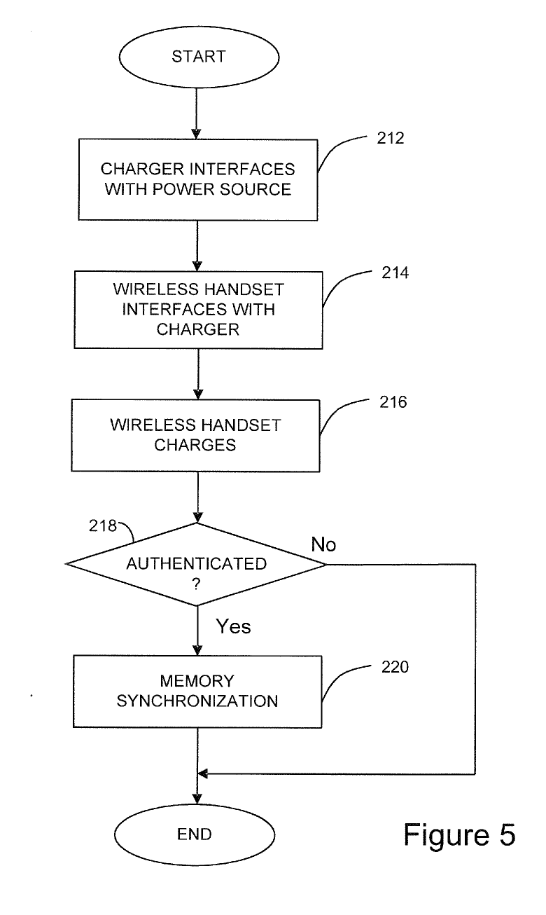

Referring to FIG. 5 there is shown an illustrative flowchart of the method for having the charger store the memory associated with the portable electronic device, e.g. wireless handset 32. The method is initiated at block 212 where the charger is attached to a power source or power supply. In the illustrative embodiment, the illustrative power comes from an AC outlet and the charger is fixedly coupled to the power source.

At block 214, the portable electronic device is attached to the charger cable. In the illustrative method, the charger charges the wireless handset 32 at 216.

In decision diamond 218, a determination is made whether the particular wireless handset is associated with the particular charger. More particularly, a verification step occurs in which the particular portable electronic device memory is associated with the particular charger with the authentication module associated with the charger. For example, authentication module 42 (in FIG. 3) performs the verification step for wireless device 32, in which charger 30 is associated specifically with wireless device 32. The data from the particular portable electronic device memory is then synchronized with the charger memory. Thus, the synchronization process between the charger memory and the wireless handset 32 may only occur with the particular handset 32.

At block 220, the handset memory is then synchronized with the charger memory. For example, the charger controller 36 provides a means for processing the data from the wireless handset memory 52 by synchronizing the device memory 52 with the charger memory 38. The charger controller 36 is configured to generate a copy of the data associated with the wireless handset memory 52. The charger controller synchronizes the copy each time the wireless handset 50 is charged. The controller proceeds to store the copy of the data in the charger memory 38.

Additionally, the charger memory may also be removed from the charger housing as described above. The method may also proceed to install the charger memory in another wireless handset 100 and enable the other wireless handset 100 to download data in the charger memory. The method may also include enabling the other wireless handset to be charged by the particular charger and enabling the other wireless handset to be synchronized by the particular charger.

It is to be understood that the detailed description of illustrative embodiments are provided for illustrative purposes. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A particular charger configured to be electrically coupled and communicatively coupled to a particular portable electronic device, wherein the particular charger comprises:
an AC/DC converter that converts alternating current to direct current and charges the portable electronic device;
a controller housed within a charger housing;
a charger memory housed within the charger housing, wherein the charger memory is communicatively coupled to the controller and the charger memory is associated with the particular portable electronic device;
a charger cable operatively coupled to the controller and to the AC/DC converter, wherein the charger cable has a first cable interface end that is configured to interface with the portable electronic device having a particular portable electronic device memory, the cable including,
at least one data cable configured to communicate data from the portable electronic device memory to the charger memory,
a power cable configured to transfer the direct current to the portable electronic device;
an authentication module associated with the charger, wherein the charger authentication module is configured to verify that the particular portable electronic device memory is associated with the particular charger; and
the controller configured to synchronize data from the particular portable electronic device memory with the charger memory.

2. The particular charger of claim 1, wherein the first cable interface end of the charger cable that interfaces with the portable electronic devices comprises a USB cable interface.

3. The particular charger of claim 1, wherein the charger cable further comprises a second cable interface end that is configured to interface with the particular charger.

4. The particular charger of claim 1, wherein the charger memory is removable from the charger housing.

5. The particular charger of claim 1, wherein the particular electronic device is a wireless handset comprising an internal memory and the charger memory is configured to synchronize with the internal memory.

6. The particular charger of claim 5, wherein the particular electronic device is a wireless handset comprising an external memory and the charger memory is configured to synchronize with the external memory.

7. The particular charger of claim 6, wherein the charger memory is removable from the charger housing and the charger memory is configured to be installed in another wireless handset, and the other wireless handset is configured to be charged by the particular charger.

8. A particular charger configured to be electrically coupled and communicatively coupled to a particular wireless handset, wherein the particular charger comprises:
an AC/DC converter that converts alternating current to direct current and charges the wireless handset;
a processing means housed within a charger housing;
a charger memory housed within the charger housing, wherein the charger memory is communicatively coupled to the processing means and the charger memory is associated with the particular wireless handset;
a charger cable operatively coupled to the means for processing and to the AC/DC converter, wherein the charger cable has a first cable interface end that is configured to interface with the wireless handset having a particular wireless handset memory, the cable including,
at least one data cable configured to communicate data from the wireless handset memory to the charger memory,
a power cable configured to transfer the direct current to the wireless handset;
an authentication module associated with the charger, wherein the charger authentication module is configured to verify that the particular wireless handset memory is associated with the particular charger; and
the processing means configured to synchronize data from the particular wireless handset memory with the charger memory.

9. The particular charger of claim 8, wherein the first cable interface end of the charger cable that interfaces with the wireless handsets comprises a USB cable interface.

10. The particular charger of claim 8, wherein the charger cable further comprises a second cable interface end that is configured to interface with the particular charger.

11. The particular charger of claim 8, wherein the charger memory is removable from the charger housing.

12. The particular charger of claim 8, wherein the wireless handset comprises an internal memory and the charger memory is configured to synchronize with the internal memory.

13. The charger of claim 12, wherein the wireless handset comprises an external memory and the charger memory is configured to synchronize with the external memory.

14. The charger of claim 12, wherein the charger memory is removable from the charger housing and the charger memory is configured to be installed in another wireless handset, and the other wireless handset is configured to be charged by the charger.

15. A method for a charger to store the memory associated with a portable electronic device, the method comprising:
enabling a charger to be fixedly coupled to a power source, wherein the charger includes,
an AC/DC converter that converts alternating current to direct current and charges the portable electronic device,
a controller housed within a charger housing,
a charger memory housed within the charger housing, wherein the charger memory is communicatively coupled to the controller and the charger memory is associated with the particular portable electronic device,
a charger cable operatively coupled to the controller and the AC/DC converter, wherein the charger cable has a first cable interface end that is configured to interface with the portable electronic device having a particular portable electronic device memory, the cable including,
at least one data cable configured to communicate data from the portable electronic device memory to the charger memory,
a power cable configured to transfer the direct current to the portable electronic device;
verifying that the particular portable electronic device memory is associated with the particular charger with an authentication module associated with the charger; and
synchronizing data from the particular portable electronic device memory with the charger memory.

16. The method of claim 15 further comprising removing the charger memory from the charger housing.

17. The method of claim 16, wherein the particular electronic device is a wireless handset comprising an internal memory and the charger memory is configured to synchronize with the internal memory.

18. The method of claim 17, wherein the wireless handset comprises an external memory and the charger memory is configured to synchronize with the external memory.

19. The method of claim 18, wherein the charger memory is removable from the charger housing, the method further comprising:
installing the charger memory in another wireless handset; and
enabling the other wireless handset to download data in the charger memory.

20. The method of claim 19 further comprising:
enabling the other wireless handset to be charged by the particular charger; and
enabling the other wireless handset to be synchronized by the particular charger.
